(19) United States
(12) Patent Application Publication
(10) Pub. No.: US 2025/0007174 A1
(43) Pub. Date: Jan. 2, 2025

(54) INTEGRATED ANTENNA AND ANTENNA APPARATUS

(71) Applicant: ZHEJIANG LAB, Hangzhou City (CN)

(72) Inventors: Xiaoyan LI, Hangzhou City (CN); Xuan LI, Hangzhou City (CN); Cheng GUO, Hangzhou City (CN); Tong HE, Hangzhou City (CN); Kuiwen XU, Hangzhou City (CN); Xianbin YU, Hangzhou City (CN)

(73) Assignee: ZHEJIANG LAB, Hangzhou City, ZJ (CN)

(21) Appl. No.: 18/264,898

(22) PCT Filed: Feb. 2, 2023
(86) PCT No.: PCT/CN2023/074271

§ 371 Date: Aug. 9, 2023

(30) Foreign Application Priority Data
Dec. 30, 2022 (CN) 202211730429.7

(51) Int. Cl. H01Q 15/00; H01Q 1/48; H01Q 13/02; H01Q 15/08; H01Q 19/02; H01Q 19/10

(52) U.S. Cl. CPC H01Q 15/002; H01Q 1/48; H01Q 13/0266; H01Q 15/08; H01Q 19/025; H01Q 19/108

(57) ABSTRACT

The present application provides an integrated antenna and an antenna apparatus. The integrated antenna includes an antenna substrate, a photodiode and an antenna radiating body. The photodiode is disposed on the antenna substrate and includes two electrodes. The antenna radiating body is disposed on the antenna substrate and connected with the two electrodes. The antenna radiating body is disposed on an upper surface of the photodiode.

### CROSS-REFERENCE TO RELATED APPLICATION

This application is the U.S. national phase of PCT Application No. PCT/CN2023/074271 filed on Feb. 2, 2023, which claims priority to Chinese Patent Application No. 202211730429.7 filed on Dec. 30, 2022, which is incorporated herein by reference in its entirety for all purposes.

### TECHNICAL FIELD

The present application relates to the field of communication technologies, and in particular to an integrated antenna and an antenna apparatus.

### BACKGROUND

With soaring communication data volume, higher requirements are proposed for a capacity and a speed of communication systems. Broadband communication becomes an important technique for solving the problems, and those photoelectric devices with broad frequency response have good application prospect in the broadband communication systems. As radio communication is upgraded even faster in the future, there is an increasingly obvious contradiction between the application requirements and the performance, size and cost of the photoelectric devices.

### SUMMARY

The present application provides an integrated antenna and an antenna apparatus to improve wideband performance.

The present application provides an integrated antenna, including: an antenna substrate; a photodiode disposed on the antenna substrate and including two electrodes; and an antenna radiating body disposed on the antenna substrate, where the antenna radiating body is connected with the two electrodes, and located on an upper surface of the photodiode.

Optionally, the antenna radiating body further includes an antenna electrode and a choke structure, both of which are disposed on the antenna substrate; and the antenna electrode and the choke structure are respectively connected with an end of the antenna radiating body.

Optionally, the antenna electrode and/or the choke structure include a squarewave-like folded line structure having a plurality of turns of rectangular metal strips.

Optionally, the antenna radiating body includes two radiation bodies and an impedance matching structure connected with the two radiation bodies; the two radiation bodies are connected with the two electrodes via the impedance matching structure.

Optionally, the photodiode is located in a central region of the impedance matching structure.

Optionally, the photodiode is embedded in the antenna substrate.

Optionally, the antenna radiating body includes a dipole antenna or a frequency-independent antenna.

Optionally, the antenna radiating body is a planar structure formed by a single layer of metal.

Optionally, the antenna substrate is of same material as a substrate of the photodiode.

The present application further provides an antenna apparatus, including: a dielectric substrate; and the integrated antenna of any one of the above embodiments, where the integrated antenna is disposed on the dielectric substrate.

Optionally, the antenna apparatus further includes a reflecting plate disposed on an upper surface of the dielectric substrate, and the integrated antenna is located directly over the reflecting plate.

Optionally, the antenna apparatus further includes a support plate disposed on an upper surface of the reflecting plate and located below the integrated antenna; the support plate supports the integrated antenna such that the integrated antenna is a distance from the reflecting plate along a height direction.

Optionally, the support plate includes a polymethacrylimide foam plate.

Optionally, a thickness of the support plate is a quarter of a wavelength corresponding to a central frequency of the integrated antenna.

Optionally, the reflecting plate is a metal plate.

Optionally, the support plate further includes a first optical fiber through hole penetrating from top to bottom, the reflecting plate further includes a second optical fiber through hole which penetrates from top to bottom and is in communication with the first optical fiber through hole, and the dielectric substrate further includes a third optical fiber through hole which penetrates from top to bottom and is in communication with the first optical fiber through hole and the second optical fiber through hole. Positions of the first optical fiber through hole, the second optical fiber through hole and the third optical fiber through hole are disposed correspondingly and are all located directly under the photodiode of the integrated antenna.

Optionally, the dielectric substrate includes a substrate body, a connection layer disposed on an upper surface of the substrate body, and a grounding layer disposed on a lower surface of the substrate body; the integrated antenna is disposed on the connection layer.

Optionally, the connection layer includes at least one first pad; the antenna apparatus further includes a gold bonding wire, and the integrated antenna is connected with the first pad via the gold bonding wire.

Optionally, the connection layer includes at least one second pad which is connected with the first pad and used to connect with a direct current connector; a communication hole penetrating from top to bottom is disposed in the substrate body, and a ground wire of the direct current connector is connected with the grounding layer through the communication hole.

Optionally, the antenna apparatus further includes a lens which is located directly over the integrated antenna and is a distance from the integrated antenna along a height direction.

Optionally, the lens is formed by 3D printing technology.

Optionally, the distance of the lens from the integrated antenna is related to a radius of the lens and a refractive index of a material of the lens.

Optionally, the antenna apparatus further includes a fixing assembly. The fixing assembly includes a plurality of fixing pieces and a bearing piece disposed above the plurality of fixing pieces. The plurality of fixing pieces are fixed on an upper surface of the dielectric substrate to support the bearing piece. The lens is disposed on the bearing piece.

In the integrated antenna and the antenna apparatus provided by the embodiments of the present application, the photodiode with broad frequency response is disposed on the antenna substrate and integrated on a lower surface of the antenna radiating body. In this way, the wideband performance of the integrated antenna can be improved. Due to high degree of integration, compact structure, reliable performance and ease of use, the integrated antenna and the antenna apparatus can be applied to a photoelectric emission front end of broadband communication systems.

### BRIEF DESCRIPTION OF THE DRAWINGS

FIG. 1 is a structural schematic diagram illustrating an antenna apparatus according to an embodiment of the present application.

FIG. 2 is a structural schematic diagram illustrating an integrated antenna according to an embodiment of the present application.

FIG. 3 is a partially-enlarged view of A1 portion of the integrated antenna shown in FIG. 2.

FIG. 4 is a partially-enlarged view of A2 portion of the integrated antenna shown in FIG. 3.

FIG. 5 is a sectional schematic diagram of the A2 portion of the integrated antenna shown in FIG. 4.

FIG. 6 is a partially-enlarged view of A3 portion of the integrated antenna shown in FIG. 2.

FIG. 7 is a diagram showing comparison of the impedance properties of the integrated antenna with and without antenna electrode and/or choke structure at its ends in the antenna apparatus according to the present application.

FIG. 8 is a comparison diagram of directivities of the integrated antenna with and without reflecting plate below and/or lens in the antenna apparatus according to the present application.

### DETAILED DESCRIPTION OF THE EMBODIMENTS

Exemplary embodiments will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present application. Rather, they are merely examples of apparatuses consistent with some aspects of the present application as detailed in the appended claims.

Terms used herein are used to only describe a particular example rather than limit the present application. Unless otherwise defined, technical terms or scientific terms used in the present application should have general meanings that can be understood by ordinary persons of skill in the art. The terms such as “first” and “second” and the like used in the specification and claims do not represent any sequence, quantity or importance, but distinguish different components. Similarly, “one” or “a” and the like do not represent quantity limitation but represent at least one. If it represents only one, separate description will be made. “Plural” or “several” means two or more. Unless otherwise indicated, the terms such as “front”, “rear”, “lower”, and/or “upper” etc. are used only for ease of descriptions rather than for being limited to one position or one spatial orientation. The term “include” or “contain” or the like is intended to refer to that an element or object appearing before “include” or “contain” covers an element or object or its equivalents listed after “include” or “contain” and does not preclude other elements or objects. “Connect” or “connect with” or the like is not limited to physical or mechanical connection but includes direct or indirect electrical connection. The singular forms such as “a”, ‘said”, and “the” used in the present application and the appended claims are also intended to include multiple, unless the context clearly indicates otherwise. It is also to be understood that the term “and/or” as used herein refers to and includes any or all possible combinations of one or more associated listed items.

The present application provides an integrated antenna including an antenna substrate, a photodiode and an antenna radiating body. The photodiode is disposed on the antenna substrate and includes two electrodes. The antenna radiating body is connected with the two electrodes and located on an upper surface of the photodiode. In the integrated antenna and an antenna apparatus provided by embodiments of the present application, the photodiode with broad frequency response is disposed on the antenna substrate and integrated on a lower surface of the antenna radiating body. In this way, the wideband performance of the integrated antenna can be improved. Due to high degree of integration, compact structure, reliable performance and ease of use, the integrated antenna can be applied to a photoelectric emission front end of broadband communication systems.

FIG. 1 is a structural schematic diagram illustrating an antenna apparatus 1 according to an embodiment of the present application. As shown in FIG. 1, the antenna apparatus 1 includes a dielectric substrate 10 and an integrated antenna 20. The integrated antenna 20 is disposed on the dielectric substrate 10. The dielectric substrate 10 may be a printed circuit board (PCB). The PCB may be a direct current feed printed circuit board capable of implementing the function of direct current circuit for test and use of the integrated antenna 20. In the present embodiment, the dielectric substrate 10 has a size of 30 mm*20 mm*1.5 mm and is made of FR-4. The integrated antenna 20 has a working frequency of 30 GHz to 80 GHz, which satisfies the requirements of broadband communication for frequency and bandwidth.

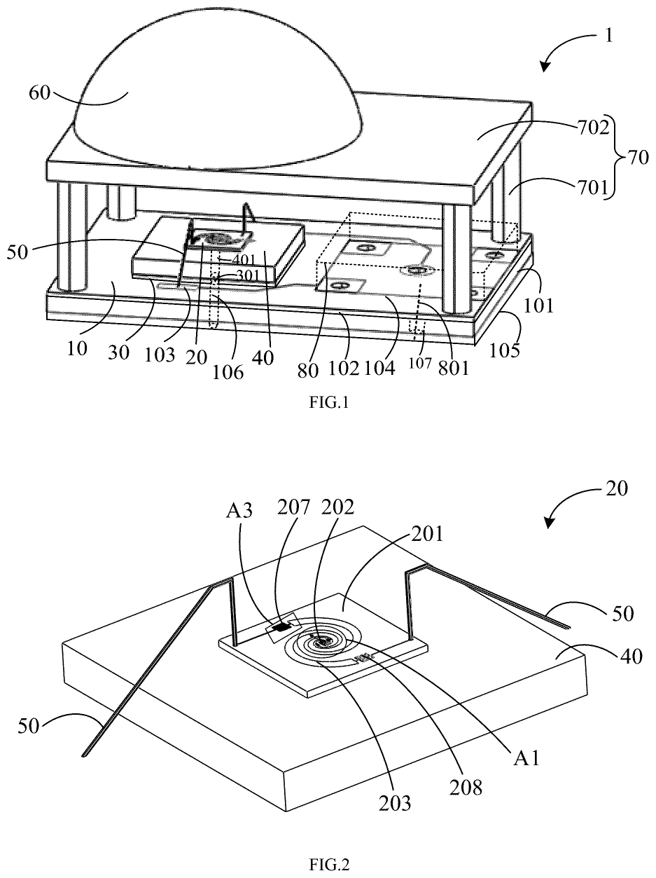

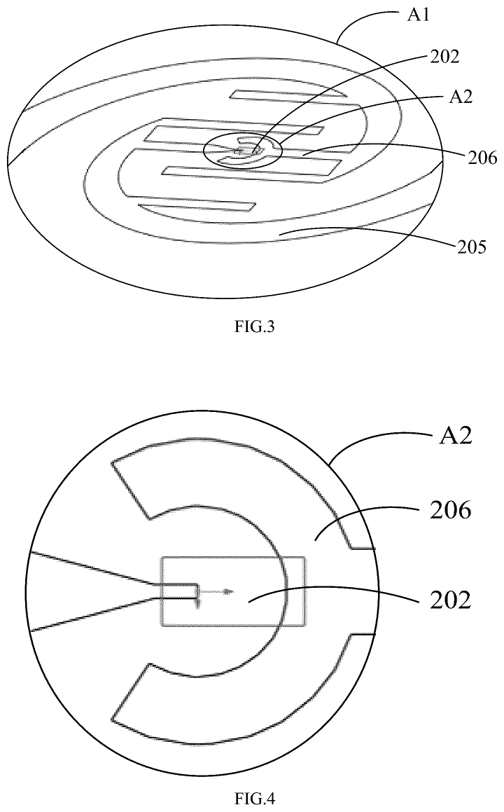

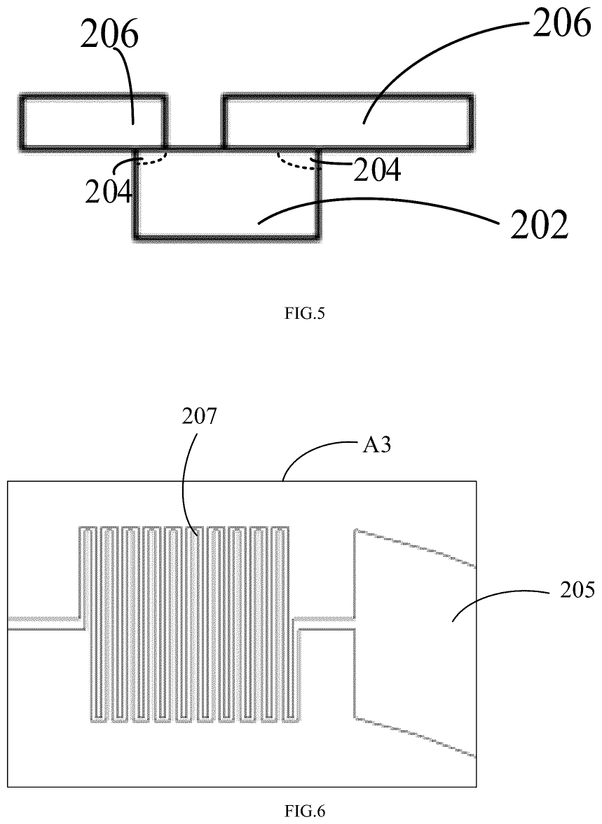

FIG. 2 is a structural schematic diagram illustrating the integrated antenna 20 according to an embodiment of the present application. FIG. 3 is a partially-enlarged view of A1 portion of the integrated antenna 20 shown in FIG. 2. FIG. 4 is a partially-enlarged view of A2 portion of the integrated antenna 20 shown in FIG. 3. FIG. 5 is a sectional schematic diagram of the A2 portion of the integrated antenna 20 shown in FIG. 4. FIG. 6 is a partially-enlarged view of A3 portion of the integrated antenna 20 shown in FIG. 2.

As shown in FIGS. 1 to 6, the integrated antenna 20 includes an antenna substrate 201, a photodiode 202, and an antenna radiating body 203. The antenna substrate 201 is used to support the photodiode 202 and the antenna radiating body 203. The antenna radiating body 203 has the property of broadband radiation and is used to transmit electromagnetic waves and hence form radiation, achieving radio transmission of signals from a guided wave structure to free space. The photodiode 202 is used to convert light signals into electric signals. The photodiode 202 is disposed on the antenna substrate 201 and includes two electrodes 204. The antenna radiating body 203 is disposed on the antenna substrate 201 and connected with the two electrodes 204. The antenna radiating body 203 is located on an upper surface of the photodiode 202. In the present embodiment, the antenna radiating body 203 includes two radiation bodies 205 and an impedance matching structure 206 connected with the two radiation bodies 205. The two radiation bodies 205 are connected with the two electrodes 204 through the impedance matching structure 206. The impedance matching structure 206 is located on the upper surface of the photodiode 202. The photodiode 202 and the antenna radiating body 203 are integrated on a surface of the antenna substrate 201, and the antenna radiating body 203 is integrated on the upper surface of the photodiode 202. In this disposal, the wideband performance of the integrated antenna 20 can be improved. Due to high degree of integration, compact structure, reliable performance and ease of use, the integrated antenna can be applied to a photoelectric emission front end of broadband communication systems.

In the embodiments shown in FIGS. 1 and 2, the antenna substrate 201 has a size of 4 mm*4 mm*0.2 mm and a material of InP. The antenna substrate 201 is same as a substrate of the photodiode 202. The antenna substrate 201 is selected of same material as the substrate of the photodiode 202 such that they can be manufactured in a same process, simplifying the process. The antenna radiating body 203 is connected with the two electrodes 204 of the photodiode 202 through the impedance matching structure 206. The two radiation bodies 205 and the impedance matching structure 206 are all located on a same surface of the antenna substrate 201, helping implementation of the integration process of the photodiode 202 and the antenna radiating body 203.

In the embodiments shown in FIGS. 1 to 5, the antenna radiating body 203 includes a dipole antenna or a frequency-independent antenna. In some embodiments, the antenna radiating body 203 includes a dipole antenna. In some embodiments, the antenna radiating body 203 includes a plurality of variation structures of the dipole antenna. In some other embodiments, the antenna radiating body 203 includes a frequency-independent antenna. The antenna radiating body 203 has a property of broadband impedance. In the embodiments shown in FIGS. 1 to 5, the antenna radiating body 203 is a planar structure formed by a single layer of metal. The planar structure can be prepared in a simple formation process. In the embodiments shown in FIGS. 3 and 4, the radiation bodies 205 each include an arc-shaped radiation arm. The arc-shaped radiation arms extend outwardly in a spiral shape from the impedance matching structure 206. The impedance matching structure 206 is of an interdigital structure. In the embodiments shown in FIGS. 3 to 5, the photodiode 202 is integrated on a lower surface of the impedance matching structure 206, and located in a central region of the impedance matching structure 206. In this embodiment, the two electrodes 204 of the photodiode 202 are located in the central region of the impedance matching structure 206. The photodiode 202 is embedded in the antenna substrate 201. The center of the antenna radiating body 203 is connected with the electrodes 204 of the photodiode 202. The metal layer is located on an upper surface of the antenna substrate 201. The impedance matching between the antenna radiating body 203 and the photodiode 202 can render transmission of power from the photodiode 202 to the antenna more effective.

In the embodiment shown in FIG. 2, the antenna radiating body 203 further includes an antenna electrode 207 and a choke structure 208. The antenna electrode 207 and the choke structure 208 are both disposed on the antenna substrate 201 and connected to an end of the antenna radiating body 203 respectively. In this embodiment, the antenna electrode 207 and the choke structure 208 are connected to an end of the two radiation bodies 205 respectively. The antenna electrode 207 is used to feed a direct current bias voltage to the photodiode 202, and the choke structure 208 is used to isolate high frequency signals.

In the embodiments shown in FIGS. 2 and 6, the antenna electrode 207 and/or the choke structure 208 includes a squarewave-like folded line structure having a plurality of turns of rectangular metal strips. In some embodiments, the antenna electrode 207 includes a squarewave-like folded line structure having a plurality of turns of rectangular metal strips. In some other embodiments, the choke structure 208 includes a squarewave-like folded line structure having a plurality of turns of rectangular metal strips. The squarewave-like folded line structure having a plurality of turns of rectangular metal strips has a principle similar to a winding inductor used at low frequency. The antenna electrode 207 is located at an end of the radiation body 205 to avoid influence of the direct current bias circuit on the impedance and radiation properties of the antenna. The squarewave-like folded line choke structure 208 is located at an end of the radiation body 205 to block transmission of high frequency signals, having the same effect as a low pass filter. Blocking the high frequency signals from coupling to the bias circuit by the squarewave-like folded line shaped choke structure 208 can effectively avoid influence of the direct current bias circuit on the impedance and radiation properties of the antenna.

In the embodiment shown in FIG. 1, the antenna apparatus 1 further includes a reflecting plate 30 disposed on the upper surface of the dielectric substrate 10. The integrated antenna 20 is located directly over the reflecting plate 30. To accommodate the integrated antenna 20, a metal region of a given size is designed as the reflecting plate 30 on a front surface of the dielectric substrate 10. The reflecting plate 30 is one layer of metal located on the upper surface of the dielectric substrate 10 which is spatially located directly under the antenna substrate 201. The reflecting plate 30 can enable the integrated antenna 20 to implement directional radiation while increasing the gain. In some embodiments, the reflecting plate 30 is a metal plate.

In the embodiment shown in FIG. 1, the antenna apparatus 1 further includes a support plate 40 disposed on an upper surface of the reflecting plate 30 and located under the integrated antenna 20. The support plate 40 supports the integrated antenna 20, such that there is a distance between the integrated antenna 20 and the reflecting plate 30 along a height direction. In some embodiments, the support plate 40 includes a polymethacrylimide foam (PMI foam for short) plate. In some embodiments, a thickness of the support plate is a quarter of a wavelength corresponding to the central frequency of the integrated antenna 20. A PMI foam of a given thickness is used as a support between the dielectric substrate 10 and the antenna substrate 201. The thickness of the PMI foam plate is determined by a working frequency band of the antenna. In this embodiment, the value of the thickness of the PMI foam plate may be a quarter of a wavelength corresponding to the central frequency, but the value is not limited hereto. In this way, the directional radiation of the integrated antenna 20 can be implemented while the gain is increased.

In some embodiments, the support plate 40 further includes a first optical fiber through hole 401 penetrating from top to bottom (shown by dotted line). In some embodiments, the reflecting plate 30 further includes a second optical fiber through hole 301 (shown by dotted line) which penetrates from top to bottom and is in communication with the first optical fiber through hole. In some embodiments, the dielectric substrate 10 further includes a third optical fiber through hole 106 (shown by dotted line) which penetrates from top to bottom and is in communication with the first optical fiber through hole and the second optical fiber through hole. The positions of the first optical fiber through hole, the second optical fiber through hole and the third optical fiber through hole are disposed correspondingly and are all located directly under the photodiode 202 of the integrated antenna 20.

In the embodiment shown in FIG. 1, the dielectric substrate 10 includes a substrate body 101, a connection layer 102 disposed on an upper surface of the substrate body 101 and a grounding layer 105 disposed on a lower surface of the substrate body 101. The integrated antenna 20 is disposed on the connection layer 102. The connection layer 102 and the grounding layer are located at both sides of the substrate body 101 respectively. In this embodiment, the dielectric substrate 10 is a double-layer plate structure, on a front surface of which a first pad 103 for connecting with a gold bonding wire 50 and a second pad 104 for connecting with a direct current connector are disposed, and on an opposite surface of which the grounding layer is disposed. The grounding layer is located at the back surface of the dielectric substrate 10.

In some embodiments, the connection layer 102 includes at least one first pad 103. The antenna apparatus 1 further includes a gold bonding wire 50. The integrated antenna 20 is connected with the first pad 103 through the god bonding wire 50. The gold bonding wire 50 can connect the integrated antenna 20 with the photodiode 202 integrated therein to the dielectric substrate 10 for ease of test and use. In some embodiments, the connection layer 102 includes at least one second pad 104 which is connected with the first pad 103. The second pad 104 is used to connect with the direct current connector 80 (shown by dotted line) which is used for input of direct current signals. The second pad 104 can facilitate input of the direct current signals and a direct current bias voltage may be applied to the antenna apparatus 1 by using the direct current connector. In this embodiment, a communication hole 107 penetrating from top to bottom is disposed in the substrate body 101, and a ground wire 801 of the direct current connector is connected with the grounding layer through the communication hole. The direct current connector is grounded via the communication hole and thus, the dielectric substrate 10 has a high degree of integration with less wires, more compact layout and smaller volume. The photodiode 202 is connected with a single chip of the integrated antenna by bonding technology, and the gold bonding wire 50 connects the antenna electrode 207 with a direct current feed structure on the dielectric substrate 10, so as to achieve connection of the single chip and the test plate. In this way, the wideband performance of the integrated antenna 20 can be improved. Due to high degree of integration, compact structure, reliable performance and ease of use, the integrated antenna can be applied to a photoelectric emission front end of broadband communication systems.

In the embodiment shown in FIG. 1, the antenna apparatus 1 further includes a lens 60 located directly over the integrated antenna 20 and having a distance from the integrated antenna 20 along a height direction. The lens 60, as a dielectric lens, is located in the antenna radiation direction and is a certain distance from the integrated antenna 20, so as to converge radiated energy of the antenna. Hence, the directivity of radiation of the antenna is better and the overall gain of the antenna apparatus is improved. In the embodiment shown in FIG. 1, the lens 60 is formed by 3D printing technology, simplifying the formation process. In the embodiment shown in FIG. 1, the antenna apparatus 1 further includes a fixing assembly 70 which includes a plurality of fixing pieces 701 and a bearing piece 702 disposed above the plurality of fixing pieces 701. The plurality of fixing pieces 701 are fixed on the upper surface of the dielectric substrate 10 by positioning holes arranged along a circumference of the dielectric substrate 10, so as to support the bearing piece 702. The lens 60 is disposed on the bearing piece 702 and located directly over the integrated antenna 20. In an embodiment, the bearing piece 702 and the lens 60 are integrally formed, leading to simple structure and compact layout. Then, the bearing piece 702 and the lens 60 are fixed on the positioning holes on the dielectric substrate 10 to achieve integration of the antenna and the lens. Thus, the entire structure of the antenna apparatus 1 is more compact.

In some embodiments, the distance of the lens 60 from the integrated antenna 20 is related to a radius of the lens 60 and a refractive index of a material of the lens 60. In this embodiment, the distance of the lens 60 from the integrated antenna 20 is a ratio of the radius of the lens 60 to the refractive index −1 of the material of the lens 60. If the height of the lens 60 from the integrated antenna 20 is h, the relationship between the height h of the lens 60 from the integrated antenna 20 and the radius of the lens 60 is: h=r/(n−1), where r is the radius of the hemisphere, and n is the refractive index of the material of the lens. By setting the height of the lens 60 from the integrated antenna 20 and the radius of the lens 60 appropriately, the directivity of radiation of the antenna will be better, and the overall gain of the antenna apparatus can be improved. In an embodiment, the lens 60 has a diameter of 20 mm.

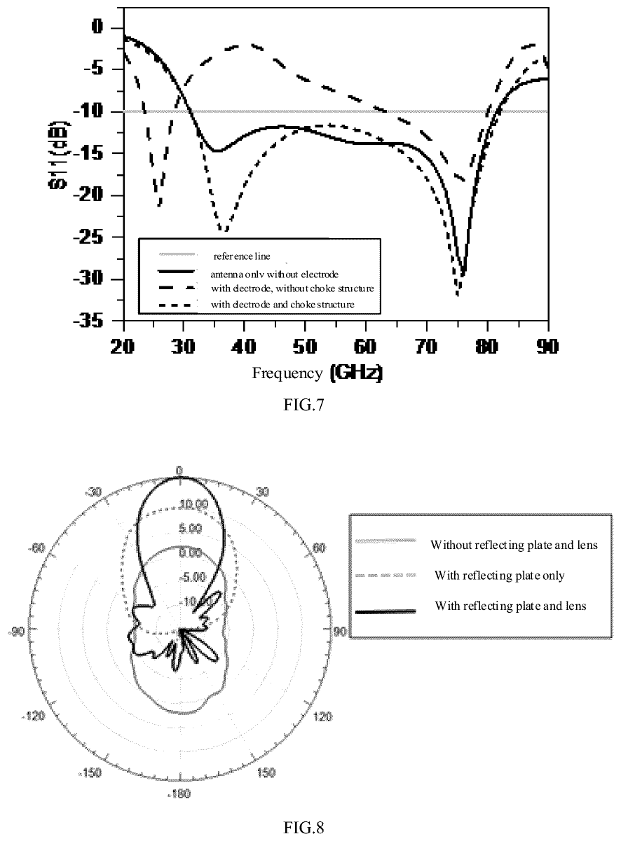

FIG. 7 is a diagram showing comparison of the impedance properties of the integrated antenna 20 with and without antenna electrode and/or choke structure at its ends in the antenna apparatus 1 according to the present application. FIG. 8 is a diagram showing comparison of directivities of the integrated antenna 20 with and without reflecting plate below and/or lens in the antenna apparatus 1 according to the present application. By using the integrated antenna 20 shown in FIGS. 1 to 6 in the present application, the ultra-broadband properties can be satisfied. As shown in FIG. 7, the black solid line represents an antenna S11 curve with only the antenna, and it can be seen that its impedance bandwidth is about 50 GHz. Further, FIG. 7 shows comparison of impedance properties of the antenna without and with antenna electrode and/or choke structure, and thus, it can be obviously concluded that the mismatch of the antenna impedance caused by the antenna electrode can be noticeably improved with introduction of the choke structure especially for the part with relatively low frequency, which indicates the choke structure 208 effectively inhibits the coupling of the high frequency signals to the antenna electrode and the bias circuit. The radiation properties of the antenna apparatus 1 are as shown in FIG. 8. FIG. 8 shows comparison of the radiation properties of the apparatus without and with reflecting plate and/or lens. Based on the principle of electromagnetic field superimposition, the reflecting plate can effectively improve the antenna gain. As shown in FIG. 8, in a case of 30 GHz, the gain of the antenna apparatus 1 is increased by 6.5 dBi after introduction of the reflecting plate 30. After the lens 60 is added, the overall gain of the integrated antenna 20 reaches 16 dBi, achieving good directional radiation. In conclusion, the design and application target of the integrated ultra-broadband antenna in the broadband communication can be accomplished.

The above descriptions are made only to preferred embodiments of the present application and shall not be used to limit the present application. Any modifications, equivalent substitutions and improvements etc. made within the spirit and principle of the present application shall all fall within the scope of protection of the present application.

1. An integrated antenna, comprising:
an antenna substrate;
a photodiode, disposed on the antenna substrate and comprising two electrodes; and,
an antenna radiating body, disposed on the antenna substrate, wherein the antenna radiating body is connected with the two electrodes, and located on an upper surface of the photodiode.

2. The integrated antenna of claim 1, wherein,
the antenna radiating body further comprises an antenna electrode and a choke structure, both of which are disposed on the antenna substrate;
the antenna electrode and the choke structure are respectively connected with an end of the antenna radiating body.

3. The integrated antenna of claim 2, wherein the antenna electrode and/or the choke structure comprise a squarewave-like folded line structure having a plurality of turns of rectangular metal strips.

4. The integrated antenna of claim 1, wherein,
the antenna radiating body comprises two radiation bodies and an impedance matching structure connected with the two radiation bodies;
the two radiation bodies are connected with the two electrodes via the impedance matching structure.

5. The integrated antenna of claim 4, wherein,
the photodiode is located in a central region of the impedance matching structure; and/or,
the photodiode is embedded in the antenna substrate.

6. The integrated antenna of claim 1, wherein,
the antenna radiating body comprises a dipole antenna or a frequency-independent antenna; and/or,
the antenna radiating body is a planar structure formed by a single layer of metal; and/or,
the antenna substrate is of same material as a substrate of the photodiode.

7. An antenna apparatus, comprising:
a dielectric substrate; and,
the integrated antenna comprising:
an antenna substrate;
a photodiode disposed on the antenna substrate and comprising two electrodes; and
an antenna radiating body, disposed on the antenna substrate, wherein the antenna radiating body is connected with the two electrodes, and located on an upper surface of the photodiode,
wherein the integrated antenna is disposed on the dielectric substrate.

8. The antenna apparatus of claim 7, wherein the antenna apparatus further comprises a reflecting plate, disposed on an upper surface of the dielectric substrate;
wherein the integrated antenna is located directly over the reflecting plate.

9. The antenna apparatus of claim 8, wherein the antenna apparatus further comprises a support plate disposed on an upper surface of the reflecting plate and located under the integrated antenna;
wherein the support plate supports the integrated antenna such that the integrated antenna is a distance from the reflecting plate along a height direction.

10. The antenna apparatus of claim 9, wherein,
the support plate comprises a polymethacrylimide foam plate; and/or,
a thickness of the support plate is a quarter of a wavelength corresponding to a central frequency of the integrated antenna; and/or,
the reflecting plate is a metal plate; and/or,
the support plate further comprises a first optical fiber through hole penetrating from top to down, the reflecting plate further comprises a second optical fiber through hole which penetrates from top to bottom and is in communication with the first optical fiber through hole, the dielectric substrate further comprises a third optical fiber through hole which penetrates from top to bottom and is in communication with the first optical fiber through hole and the second optical fiber through hole, and positions of the first optical fiber through hole, the second optical fiber through hole and the third optical fiber through hole are disposed correspondingly and are all located directly below the photodiode of the integrated antenna.

11. The antenna apparatus of claim 7, wherein,
the dielectric substrate comprises a substrate body, a connection layer disposed on an upper surface of the substrate body, and a grounding layer disposed on a lower surface of the substrate body;
the integrated antenna is disposed on the connection layer.

12. The antenna apparatus of claim 11, wherein,
the connection layer comprises at least one first pad;
the antenna apparatus further comprises a gold bonding wire, and the integrated antenna is connected with the first pad via the gold bonding wire.

13. The antenna apparatus of claim 12, wherein,
the connection layer comprises at least one second pad which is connected with the first pad and used to connect with a direct current connector;
a communication hole penetrating from top to bottom is disposed in the substrate body, and a ground wire of the direct current connector is connected with the grounding layer through the communication hole.

14. The antenna apparatus of claim 7, wherein the antenna apparatus further comprises a lens,
wherein the lens is located directly over the integrated antenna and is a distance from the integrated antenna along a height direction.

15. The antenna apparatus of claim 14, wherein,
the lens is formed by 3D printing technology; and/or,
the distance of the lens from the integrated antenna is related to a radius of the lens and a refractive index of the lens.

16. The antenna apparatus of claim 14, wherein the antenna apparatus further comprises a fixing assembly,
wherein the fixing assembly comprises a plurality of fixing pieces and a bearing piece disposed above the plurality of fixing pieces;
the plurality of fixing pieces are fixed on an upper surface of the dielectric substrate to support the bearing piece;
the lens is disposed on the bearing piece.

17. The antenna apparatus of claim 7, wherein
the antenna radiating body further comprises an antenna electrode and a choke structure, both of which are disposed on the antenna substrate;
the antenna electrode and the choke structure are respectively connected with an end of the antenna radiating body.

18. The antenna apparatus of claim 17, wherein the antenna electrode and/or the choke structure comprise a squarewave-like folded line structure having a plurality of turns of rectangular metal strips.

19. The antenna apparatus of claim 7, wherein,
the antenna radiating body comprises two radiation bodies and an impedance matching structure connected with the two radiation bodies;
the two radiation bodies are connected with the two electrodes via the impedance matching structure.

20. The antenna apparatus of claim 19, wherein,
the photodiode is located in a central region of the impedance matching structure; and/or,
the photodiode is embedded in the antenna substrate.
